(19) United States
(12) Patent Application Publication
(10) Pub. No.: US 2009/0307320 A1
(43) Pub. Date: Dec. 10, 2009

(54) ELECTRONIC MAIL PROCESSING UNIT INCLUDING SILVERLIST FILTERING

(76) Inventors: Tal Golan, Irvine, CA (US); Cameron Brown, Irvine, CA (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/136,697

(22) Filed: Jun. 10, 2008

(51) Int. Cl. G06F 15/16

(52) U.S. Cl. 709/206

(57) ABSTRACT

Systems and methods of filtering received messages to discard unsolicited messages using silverlist filters and combinations of silverlist filters and other types of filters are disclosed. In many embodiments, an appliance remote from a mail server is used to filter messages using at least a silverlist filter prior to forwarding messages to the mail server. In a number of embodiments, a mail server applies a filtering process that includes a silverlist filter and a challenge response filter. One embodiment of the method of the invention includes receiving a message envelope sent from a sender IP address, where the message envelope includes a sender address and at least one recipient address, determining the reputation of the sender IP address, allowing the message when the sender has a reputable sender IP address, irrespective of the sender and recipient addresses, and performing a test when the sender IP address has unknown reputation. In addition, the test includes issuing a temporary failure to the sender, detecting as a retry a message envelope received within a predetermined time period, where the sender and recipient addresses of the original message envelope and the received message envelope correspond, and allowing the retry message.

### BACKGROUND

The present invention relates generally to message processing systems and more specifically to message processing systems that automatically filter messages believed to be unsolicited advertisements.

Unsolicited messages can pose a significant problem for users of message services such as email. A number of systems attempt to filter undesired messages using complex filtering algorithms that inspect the content of the message. Other systems attempt to filter messages using more straightforward approaches such as requesting that unknown senders provide an acknowledgement prior to the message being forwarded. Such systems are commonly known as challenge response systems. A challenge response system typically maintains a whitelist of authorized senders and often contains a blacklist of senders that are not authorized to send mail. When a message is received from someone who is neither on the whitelist or the blacklist, then a challenge message is sent out that requires a response within a predetermined period of time for the message to be released to the intended recipient. If a response is received, the message is released to the recipient and the sender is added to the recipient's whitelist.

Another approach for preventing unsolicited messages is a technique called greylisting that involves looking at identifying information on an incoming email (a triplet including IP address of the host attempting delivery, the envelope sender address and the envelope recipient address) and refusing acceptance of emails with identifying information that has not previously been recognized by issuing a temporary failure message. SMTP is considered unreliable and the possibility of temporary failures is built into the protocol. As such, the message transfer agent of a legitimate sender will attempt to resend a message in response to receipt of a temporary failure code. However, the vast majority of unsolicited messages are sent from applications designed specifically for spamming that do not attempt retries. Therefore, greylisting can have high levels of effectiveness in blocking unsolicited messages and allowing legitimate messages.

Many greylist filters encounter issues when receiving messages from mail server farms typical of large organizations, Internet Service Providers and web email providers. If a pool of mail servers shares responsibility for sending a message, then subsequent delivery attempts for the message will often come from servers in the farm with different IP addresses. A typical greylist filter requires the IP address of the retry to match the IP address of the original attempt. Therefore, the pool of mail servers can make numerous retry attempts before one server attempts delivery twice. The larger the pool, the longer the potential delay (or possibility of non-delivery) until the server that originally transmitted the message is assigned responsibility for the retry.

### SUMMARY OF THE INVENTION

Systems and methods of filtering messages using at least a silverlist filter are described. In a number of embodiments, the silverlist filter uses an IP address based reputation database and applies a silverlist test to messages having a sender IP address of unknown reputation. A silverlist test involves issuing a temporary failure and then allowing the message after receipt of a retry. In many embodiments, any retry with corresponding sender and recipient addresses is acceptable. In many embodiments, a mail processing unit implemented as an appliance remote from a mail server is used to perform silverlist filtering. In a number of embodiments, the appliance applies a combination of filters to messages intended for a remote mail server including silverlist, challenge response and/or statistical filtering. In one embodiment, the appliance is a gateway appliance to a mail server that includes a separate full service message handling system to implement silverlist filtering and challenge response filtering of messages destined for the mail server. In several embodiments, a mail server applies a silverlist filter prior to allowing received messages.

One embodiment of the method of the invention includes receiving a message envelope sent from a sender IP address, where the message envelope includes a sender address and at least one recipient address, determining the reputation of the sender IP address, allowing the message when the sender has a reputable sender IP address, irrespective of the sender and recipient addresses, and performing a test when the sender IP address has unknown reputation. In addition, the test includes issuing a temporary failure to the sender, detecting as a retry a message envelope received within a predetermined time period, where the sender and recipient addresses of the original message envelope and the received message envelope correspond, and allowing the retry message.

In a further embodiment of the method of the invention, determining the reputation of the sender IP address of each message includes determining whether the sender IP address has passed the test within a predetermined time period.

In another embodiment of the method of the invention, determining whether the sender IP address has passed the test within a predetermined time period comprises consulting a reputation database containing a listing of sender IP addresses that have passed the test within a predetermined time period.

In a still further embodiment of the method of the invention, consulting said reputation database includes querying a local reputation database.

In still another embodiment of the method of the invention, consulting said reputation database includes sending a query to a remote reputation server.

A yet further embodiment of the method of the invention includes storing reputation information concerning a sender IP address in said reputation database in response to the outcome of said test.

In yet another embodiment of the method of the invention, the message has a plurality of recipient addresses and further comprising performing said test with at least two of the recipient addresses.

A further embodiment again of the method of the invention also includes determining whether a recipient has authorized performance of the test.

Another embodiment again of the method of the invention also includes determining whether the sender and recipient addresses of the original message envelope and the retried message envelope correspond using hash values of the addresses.

In a further additional embodiment of the method of the invention, detecting a received message as a retry further includes determining that the sender and recipient addresses of the original message envelope and the received message envelope correspond, and determining that the sender IP addresses of the original message envelope and the received message envelope correspond.

Another additional embodiment of the method of the invention also includes comparing the sender address of the message envelope to a whitelist of sender addresses, and allowing messages where the sender address of the message envelope appears on the whitelist.

A still yet further embodiment of the invention also includes comparing the sender address of the message envelope to a blacklist of sender addresses, and refusing to allow messages where the sender address of the message envelope appears on the blacklist.

Still yet another embodiment of the method of the invention also includes applying a challenge response filtering process to messages that are allowed.

In a still further embodiment again of the method of the invention, the challenge response filter process includes sending a challenge message to the sender of the allowed message, and providing the allowed message to the recipient when an appropriate response to the challenge message is received from the sender of the allowed message.

In still another embodiment again of the method of the invention, the challenge response filtering process includes comparing the sender address of the allowed message to a whitelist of sender addresses, providing the allowed message to the recipient when the sender address of the allowed message is on the whitelist, comparing the sender address of the allowed message to a blacklist of sender addresses, rejecting the allowed message when the sender address of the allowed message is on a blacklist, sending a challenge message to the sender address of the allowed message when the sender of the allowed message is neither on the whitelist or the blacklist, and providing the allowed message to the recipient when an appropriate response to the challenge message is received from the sender of the allowed message.

A still further additional embodiment of the method of the invention also includes applying a content filtering process to messages that are allowed by the silverlist filter.

In still another additional embodiment of the method of the invention, the message is destined for a remote mail server and the filtering process includes forwarding messages that pass the filtering process to the remote mail server.

An embodiment of the invention includes a network connection configured to receive connection information, message envelopes, and message data, where the connection information includes a sender IP address, and message envelopes include a sender address and a recipient address, and a processor configured to determine the reputation of the sender IP address of each message. In addition, the processor is further configured to allow messages from senders having reputable sender IP addresses, and the processor is further configured to perform a test on messages from senders of messages having an IP address of unknown reputation. The test includes transmitting a temporary failure message via the network connection to the sender of the a message having an IP addresses of unknown reputation, and detecting as a retry a message envelope received via the network connection within a predetermined time period, where the sender and recipient addresses of the original message envelope and the received message envelope correspond, and allowing the retry message.

In a further embodiment of the invention, the processor is configured to determine the reputation of a sender IP address by determining whether the sender IP address has passed said test within a predetermined time period.

In another embodiment of the invention, the processor is configured to determine whether the sender IP address has passed said test within a predetermined time period by consulting a reputation database containing a listing of sender IP addresses that have passed the test within a predetermined time period.

In a still further embodiment of the invention, the processor is configured to query a local reputation database.

In still another embodiment of the invention, the processor is configured to transmit a query to a remote reputation server via the network connection.

In a yet further embodiment of the invention, the processor is further configured to store reputation information in the reputation database concerning a sender IP address in response to the outcome of the test.

In yet another embodiment of the invention, the processor is configured to perform the test with respect to multiple recipient addresses, when a message includes a plurality of recipient addresses.

In a further additional embodiment of the invention, the processor is configured to determine whether a recipient has authorized performance of the test prior to performing the test.

In another additional embodiment of the invention, the processor is configured to determine whether the sender and recipient addresses of the original message envelope and the retried message envelope correspond using hash values of the addresses.

In a still yet further embodiment of the invention, the processor is configured to detect a received message as a retry by determining that the sender and recipient addresses of the original message envelope and the received message envelope correspond, and determining that the sender IP addresses of the original message envelope and the received message envelope correspond.

In still yet another embodiment of the invention, the processor is configured to apply a whitelist filter to received message envelopes including comparing the sender address of the message envelope to a whitelist of sender addresses, and allowing messages where the sender address of the message envelope appears on the whitelist.

In a still further embodiment again of the invention, the processor is configured to apply a blacklist filter to received message envelopes including comparing the sender address of the message envelope to a blacklist of sender addresses, and refusing to allow messages where the sender address of the message envelope appears on the blacklist.

In still another embodiment again of the invention, the processor is further configured to apply a challenge response filter to allowed messages.

In a still further additional embodiment of the invention, the processor is further configured to send a challenge message to the sender of the allowed message, and provide the allowed message to the recipient when an appropriate response to the challenge message is received from the sender of the allowed message.

In still another additional embodiment of the invention, the processor is further configured to provide the allowed message to the recipient when the sender address of the allowed message is on a whitelist, reject the allowed message when the sender address of the allowed message is on a blacklist, send a challenge message to the sender address of the allowed message when the sender address of the allowed message is neither on the whitelist or the blacklist, and provide the allowed message to the recipient when an appropriate response to the challenge message is received from the sender of the allowed message.

In a yet further embodiment again of the invention, the processor is further configured to apply a content filter to allowed messages.

In yet another embodiment again of the invention, the message is destined for a remote mail server and the processor is configured to forward allowed messages to the remote mail server.

### BRIEF DESCRIPTION OF THE DRAWINGS

FIG. 1 is a schematic diagram of a network including mail processing systems in accordance with an embodiment of the invention.

FIG. 1a is a flow chart showing a silverlisting process in accordance with an embodiment of the invention

FIG. 2 is a conceptual illustration of a mail processing unit in accordance with an embodiment of the invention.

FIG. 3 is a flow chart showing a process used by a combined silverlist and challenge response filter on incoming messages in accordance with an embodiment of the invention.

FIG. 4 is a flow chart showing a process for performing silverlist filtering on messages destined for a message in combination with content analysis filtering and challenge response filtering in accordance with an embodiment of the invention.

FIG. 5 is a flow chart of a process for performing silverlist filtering to prevent spoofing in accordance with an embodiment of the invention.

### DETAILED DESCRIPTION OF THE INVENTION

Turning now to the drawings, embodiments of mail processing systems are shown. In a number of embodiments, the mail processing systems apply a silverlist filter to incoming messages and, in many embodiments, apply a silverlist filter in combination with one or more additional filtering techniques. Silverlist filtering is a reputation based filtering technique that tracks the reputation of SMTP servers using a sender IP address based reputation database. Silverlist filtering is distinct from greylist filtering in that a greylist filter tracks each unique combination of recipient address, sender address, and sender IP address as a separate conversation that carriers its own reputation. A silverlist filter in accordance with an embodiment of the invention, by contrast, operates on the principle that retry is an SMTP server behavior independent of the sender and recipient addresses involved in a message transmission. Therefore, a silverlist filter relies on the reputation of the sender's IP address only. In many embodiments, the silverlist filters acknowledge that retry attempts from mail server farms can be independent of the sender IP address of the message. Therefore, the silverlist test applied by most silverlist filters involves issuing a temporary failure and allowing retries where the sender and the recipient addresses match. Not requiring the IP address to match accommodates server farms where responsibility for sending the original message and the retry is allocated to different servers. Although in embodiments where additional delay can be tolerated, the silverlist test requires the sender IP address of the original and retry messages to match.

The reputation tracked by a greylist filter (i.e., the reputation of a sender address, recipient address, and sender IP address) can be referred to as “conversation reputation” and the reputation tracked by a silverlist filter (i.e., sender IP address only) can be referred to as “server reputation”. Conversation reputation is very granular and is difficult to share amongst filters. In real world applications, two distinct mail systems typically will not receive messages addressed to the same recipient. Therefore, conversation reputation accumulated by a greylist filter of a first mail system, which is expressed in terms of a recipient address, is not usable by a greylist filter of a second mail system. Server reputation is independent of a message's recipient address. Therefore, silverlist filters can share server reputation and reduce the number of temporary failures issued by each filter when filtering unsolicited messages. In many embodiments, silverlist filters share a common global reputation database. In several embodiments, silverlist filters can maintain a local reputation database and/or rely upon a global reputation database. In a number of embodiments, a subset of silverlist filters has permission to update the global reputation database and other silverlist filters have read-only access to the global reputation database.

The principles of operation of a silverlist enable the filter to issue significantly fewer temporary failures than would be issued by a conventional greylist filter. Many businesses are extremely sensitive to message delays. Therefore, silverlist filters can increase user satisfaction by filtering unsolicited messages in a similar manner to a conventional greylist filter in a way that results in fewer delayed messages. Many organizations consider conversational patterns sensitive information. Therefore, global reputation databases in accordance with several embodiments of the invention aggregate reputation information without recording conversational patterns. In a number of embodiments, server reputation information is stored using hashes of the sender address and the recipient address. Therefore, analysis of the database does not yield information concerning conversation patterns. However, hashes can be used to match sender and recipient address and detect a retry from a different server in a server farm.

In a number of embodiments, the mail processing system is a separate appliance isolated from a mail server that filters messages destined for a mail server using at least silverlist filtering and, in many embodiments, using one or more additional filtering techniques. In many embodiments, the separate appliance is itself a full service mail system and can perform silverlist and challenge response filtering of messages destined for a mail server. In other embodiments, the mail processing system is integrated with a mail server and applies silverlist and challenge response filters to incoming messages. In a number of embodiments, the mail processing system is implemented as a virtual machine on a remote server using a virtualization service.

### Mail Processing Systems

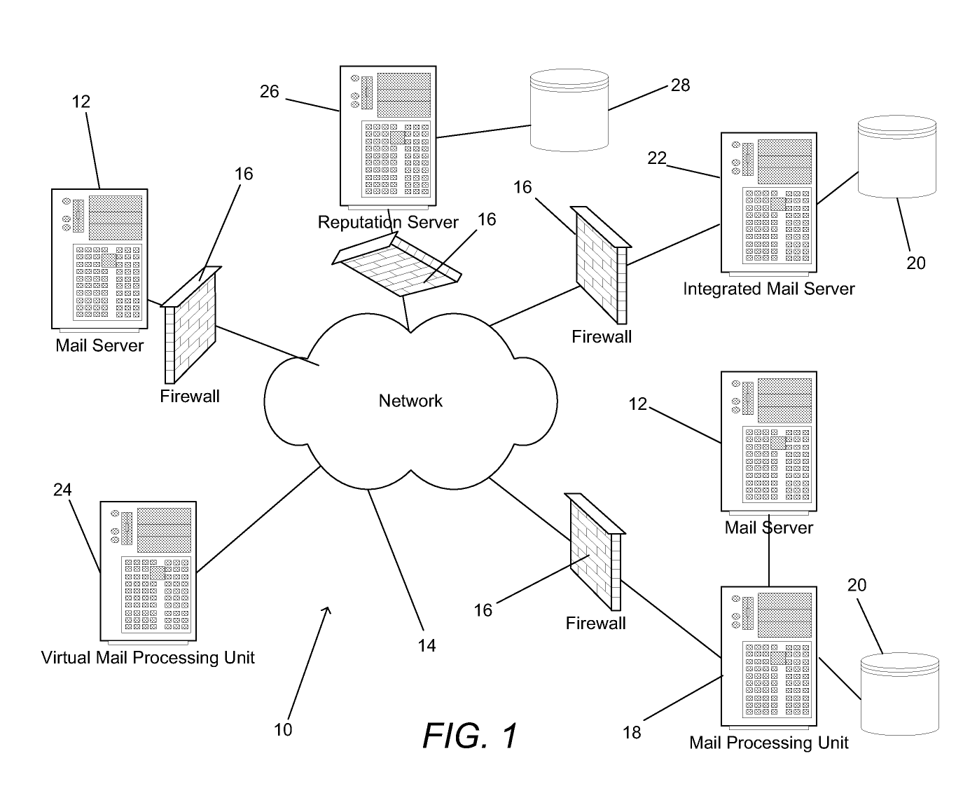

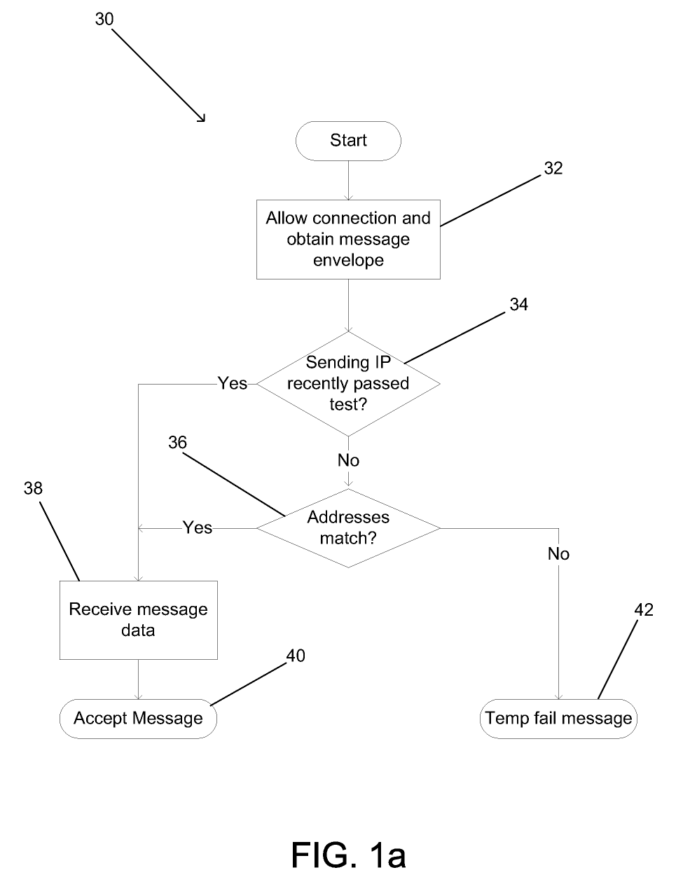

An embodiment of a mail processing system in accordance with an embodiment of the invention is shown in FIG. 1. The mail processing system 10 includes a number of mail servers 12 that are connected to a network 14 via firewalls 16. In several embodiments, messages to and from a mail server must pass through a mail processing unit 18 that can include a reputation database 20. The mail processing unit 18 is typically a separate appliance that is isolated from the mail server 12. However, in many embodiments the mail processing unit can be integrated with the mail server to create an integrated mail server 22, which can include a reputation database 20. In a number of embodiments, the mail processing unit is implemented virtually 24 on one or more remote servers maintained by a virtualization service. A remote reputation server 26 is also connected to the network 14 via a firewall 16. The reputation server is connected to a shared reputation database 28.

Each mail processing unit 18 intercepts messages destined for an associated mail server 12 and filters the messages to block unsolicited messages and to forward messages to the mail server that appear to be from legitimate senders. In many embodiments, the mail processing unit admits messages using at least a silverlist filter and the silverlist draws upon server reputation information maintained in a reputation database. In several embodiments, the reputation database is maintained locally. In a number of embodiments, the silverlist filter relies upon a remote or shared reputation database. The silverlist filter can protect network bandwidth and reduce load on a mail server by preventing the transmission of the message payload of unsolicited messages. Implementations of a variety of silverlist filters in accordance with embodiments of the invention are discussed below.

### Silverlist Filters

A silverlist filter uses information concerning the reputation of an IP address to determine whether to immediately allow a mail message, or to issue a temporary failure. Mail processing units in accordance with embodiments of the invention maintain a reputation database or some other system for maintaining server reputation information. The reputation database can provide information concerning whether an IP address has a good reputation, or an inconclusive reputation. In several embodiments, the reputation database can also indicate whether an IP address has a bad reputation. When an IP address has a good reputation, the message is automatically allowed. A bad reputation leads to the automatic rejection of the message. When an IP address has an inconclusive reputation, then the system issues a temporary failure. An IP address typically acquires a good reputation when a silverlist filter determines the server at that IP address is able to pass a silverlist temporary failure test. In a number of embodiments, the IP address can acquire a bad reputation according to criteria appropriate to the application, such as demonstration of inability to pass some number of silverlist tests, either from a single filter or across a number of filters. As discussed above, reputation information can be shared between silverlist filters and the server at the IP address can benefit from good reputation established by passing a silverlist temporary failure test previously conducted by another silverlist filter.

When the reputation of an IP address is inconclusive, the silverlist filter issues a temporary failure and waits for the message to be retried. Unlike many implementations of greylist filters, a silverlist filter does not require that the message be retried from the same IP address as the original message. The silverlist filter simply requires that the sender address and the recipient address of the original and retried messages match. Matching IP addresses are not required due to the number of large mail systems that include multiple sending servers and may not assign the original server with responsibility for delivering a retry. Although not required, embodiments that can tolerate additional delay often provide the option of utilizing a silverlisting test that involves matching IP addresses, sender addresses and recipient addresses.

In a number of embodiments, a sliverlist test is combined with a whitelist and a message will automatically pass the silverlist filter when the sender address is within the recipients contacts. In several embodiments, a message automatically passes the silverlist filter when the sender address is listed as a contact of any user of the recipient's mail server. In several embodiments, a silverlist test is combined with a blacklist of sender addresses. In embodiments where silverlist filtering is combined with challenge response filtering, the failure of a previous message from the IP address to pass the challenge response test can be the basis for adding the sender's address to a blacklist. Irrespective of whether a blacklist or whitelist is used in determining whether to allow a message, a silverlist filter determines reputation using, amongst other tests, whether the IP address has passed a silverlist test within a predetermined time period (e.g., 30 days) when reputation is not otherwise dictated by the sender IP reputation database.

Although specific aspects of silverlist filters are described above, silverlist filters can take on a variety of forms. Various silverlist filters can be categorized based upon the technique used by the filter to determine the reputation of an IP address and the test applied to a retried message. Specific embodiments of silverlist filters, including silverlist filters in combination with other filters, are discussed below.

### Application of a Silverlist Filter

A process for applying a silverlist filter to a received message in accordance with an embodiment of the invention is shown in FIG. 1a. The process 30 commences with receipt of a request to establish a connection for the purpose of transmitting a message. The connection is allowed (32) and the message envelope is obtained. In many embodiments, the sender IP address is obtained from the request to establish a connection and the message envelope includes a sender email address, and a recipient email address. The process determines (34) whether the sender IP address has recently passed a temporary failure test. In many embodiments, the process determines whether the sender IP has passed a temporary failure test within a specifically configurable window of time that can be of arbitrary duration. As discussed above, the information can be obtained from a reputation database compiled by the filter and/or other connected filters. When the sender IP address has recently passed the temporary failure test, the sender is permitted to transmit the message data. When the message data has been received (38), the message is allowed by the filter. In embodiments where the filter is implemented as part of a mail server, allowing the message can be a process as simple as placing the message in the appropriate recipient's inbox. When the filter is implemented on a separate appliance, allowing the message can include storing the message in a local database and forwarding the message to the destination mail server.

When the IP address has not recently passed a temporary failure, the process determines (36) whether the sender and recipient email addresses correspond to the sender and recipient email addresses of a message that has recently been the subject of a temporary failure. As discussed above, the sender IP address need not match due to a desire to admit messages retries sent from different servers within a mail server farm. In the event that the addresses match (or proxies for the addresses such as hash values), then the message is assumed to be a retry in response to the temporary failure, the message data is requested, and the message allowed. In many embodiments, the process consults a reputation database that includes a “waiting” record for each temporary failure issued by the filter. In several embodiments, the “waiting” record is only maintained for a predetermined period of time (typically 24 hours). Imposing a maximum allowable retry time can prevent the size of the “waiting” record table from growing to an unmanageable size on a busy system. In a number of embodiments, a minimum allowable retry time is also required. Many bulk email systems are active for a brief period of time. By imposing a minimum allowable retry time beyond the period of operation of a bulk email system, messages from the bulk email system can be filtered even though the bulk email system may possess the capacity to issue retries. In many embodiments, a minimum retry time of one minute is required. The minimum retry time typically depends upon the application. In circumstances where users are sensitive to message delays, then the retry time can be reduced. Use of a global reputation database can decrease the number of retires and enable greater tolerance for message delays.

When the process maintains “waiting” records and a retry is received within the specified time window, embodiments that maintain local reputation information can promote the “waiting” record to a good reputation record that expires 30 days after creation. In other embodiments, good reputation records are also published to a global reputation database. The publication typically occurs in a period batch update. In a number of embodiments, the filter does not collect any local reputation information. Instead, the filter relies on global reputation information compiled by other filters.

When the message is determined to not be a retry, then the process issues a temporary failure (42). In many embodiments, a temporary failure is issued on behalf of each recipient listed in the message header. In several embodiments, the system can selectively apply the silverlist filter on a per recipient address basis depending upon the preferences expressed by each recipient. As part of the process of issuing a temporary failure, information from the message envelope is added to the reputation database. In many embodiments, the information is incorporated into a “waiting” record created within the database. The information recorded in the “waiting” record can include the sender IP address, and the sender and recipient email addresses. Although the sender IP address is often not required to determine whether a message is retry, the sender IP address is stored so that it can be added to the reputation database in the event that a retry is received. In many embodiments, the original sender IP address is added to the reputation database. In several embodiments, both the original sender IP address and the retry sender IP address are added to the reputation database. In embodiments where reputation information is aggregated across multiple filters, hashes of the sender and recipient email addresses can be stored as a proxy for the actual addresses to preserve the privacy of the sender and the recipient.

Although the illustrated embodiment uses a single test to determine reputation, many silverlist filters combine a test similar to the test shown in FIG. 1a in combination with any number of other tests, such as tests to determine the legality of the sender and recipient IP addresses (i.e., whether the addresses conform to rules concerning the content and formatting of IP addresses), for the purposes of determining the reputation of an IP address. In addition, many mail processing units in accordance with embodiments of the invention combine a silverlist filtering process similar to the process shown in FIG. 1a with other filtering processes, such as a whitelist, a blacklist, a content filter and/or a challenge response filter. Various mail processing units and filter combinations are discussed below.

### Silverlist Filtering Using a Remote Appliance

Filtering messages in a separate location offers the advantage that multiple mail servers and/or an individual's mail accounts maintained on separate mail servers can share sender IP address reputation information, whitelists, blacklists and/or additional information collected during the filtering process. In addition, a separate appliance located on the same local network as a mail server can reduce network congestion by rejecting unsolicited messages based upon the message envelope and without the need to allow the payload portion of rejected messages. Furthermore, the processing burden sits with the appliance and not with a mail server that could be destabilized by the additional processing burden.

### Mail Processing Units

A mail processing unit in accordance with embodiments of the invention is typically implemented on a server or custom appliance that is separate from the mail server associated with the mail processing unit. Implementing the mail processing unit as a separate appliance can ease the load on the mail server protected by the mail processing unit. Mail servers can be unstable and, therefore, using separate servers to perform the functions of the mail processing unit and the mail server can reduce the risk of mail server failure. In applications where the stability of the mail server is less of a concern, the mail processing unit can be implemented as a software application that is installed on a server either in addition to a mail server application or as an integrated mail processing unit/mail server application. Such an implementation can be advisable for reducing the cost of deployment. As will be discussed further below, a mail processing unit that combines silverlist and challenge response filtering utilizes message handling functionality when performing filtering. A simple implementation utilizes the mail server's message handling functionality. Duplicating the mail handling functionality on a gateway appliance and decoupling the mail processing unit from the mail server, however, enables the mail server to devote a majority of its resources to processing legitimate mail messages. As discussed above, the separate appliance can be an actual device or can be implemented using virtualization technology as a virtual device on a remote server.

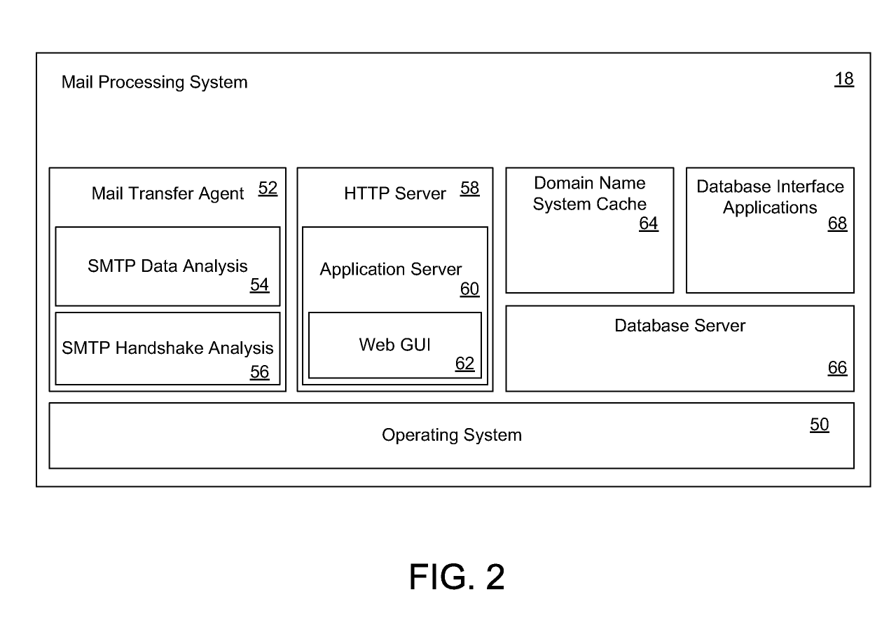

A conceptual illustration of the components of a mail processing unit that includes message handling functionality in accordance with an embodiment of the invention is shown in FIG. 2. The mail processing unit 18 includes an operating system, such as a Linux variant, on which a number of applications sit. The illustrated mail processing system includes a mail transfer agent 52, which is responsible for the handling of all messages passing through the mail processing unit. The mail transfer agent 52 includes a process for performing SMTP Data Analysis 54 on received messages and a process for performing SMTP Handshake Analysis 56. The SMTP Handshake Analysis 56 process can analyze incoming mail messages and perform appropriate filtering. The filtering can involve silverlist filtering and can also involve use of challenge response filtering. In addition to the mail transfer agent, the mail processing unit 18 includes an HTTP server 58. The HTTP server enables the mail processing unit 18 to provide information to an administrator via an application server 60 that supports a web based graphical user interface 62. In many embodiments, the mail processing unit includes a Domain Name System cache 64 that enables the mail processing unit to perform and cache DNS look ups locally (which can ease the burden on the DNS server of a corporate network). Mail processing units also typically include a database. In the illustrated embodiment, the mail processing unit 18 includes a database server 66 and a set of database interface applications 68 that enable other applications within in the mail processing unit to exchange information with the database. The database can be used to store information relevant to the filter implementation and, in the manner outlined in U.S. patent application Ser. No. 11/745,950 entitled “Mail Processing System”, the disclosure of which is incorporated herein by reference in its entirety, to store and organize messages. In many embodiments, the database includes an IP reputation table that includes rows with at least the two fields: sender IP address; and expiration time. The database can also include a “waiting” record table, where each waiting record includes the following fields: sender IP address; sender address hash; recipient address hash; minimum required retry time; and expiration time. In other embodiments, the database can store data used in the implementation of silverlist and other filters in formats appropriate to the application.

While the mail processing unit may admit a message that passes the silverlist and/or other filters, the mail processing unit can often block or restrict access to undesirable attachments. In several embodiments, mail processing units attempt to extract information from received messages for storage in the mail processing unit's database. In a number of embodiments, the information is stored in fields to facilitate location of messages and information within the database. In addition to handling messages received via the network, mail processing units in accordance with embodiments of the invention process messages forwarded by a mail server for transmission via the network. In many embodiments, the message is buffered. In several embodiments, the buffering of the message enables recall of the message, rerouting of the message and/or delay of the message pending a predetermined time or event such as user authorization to send the message. Techniques for handling messages destined for and emanating from a mail server by a mail processing unit are discussed in U.S. patent application Ser. No. 11/745,950.

When the mail processing unit only implements a silverlist filter, the mail processing unit can be implemented using a so called “gum stick” computer, which is a very small and relatively inexpensive stand alone computing device that typically does not include hard disk storage. The “gum stick” computer can be deployed as a gateway device within a corporate network and can be placed inside or outside of the corporate firewall. The ability to deploy a “gum stick” computer typically depends upon the “gum stick” computer having a considerable amount of storage to maintain “waiting” and reputation records. Alternatively, the “gum stick” computer can operate in conjunction with a reputation server that maintains “waiting” and reputation records for a number of devices.

When multiple appliances load-balance the incoming mail stream in such a way that it is possible for the retry of a temporary failed message to go to an appliance other than the appliance that issued the temporary failure, then the appliances can store reputation information in a single reputation database to prevent messages from being temporary failed multiple times before the retries are recognized as such. In a number of embodiments, “gum stick” computers can be used in combination with a reputation server that maintains a reputation database on behalf of each of the “gum stick” computers to perform load sharing.

Although specific examples of mail processing units are described above, any of a variety of software and/or hardware combinations, including virtual implementations, can be employed in the implementation of a mail processing unit that perform silverlist filtering operations in accordance with embodiments of the invention.

### Silverlist and Challenge Response Filtering

As discussed above, mail processing units in accordance with embodiments of the invention can implement combinations of filters. In many embodiments, combination of filters can lead to efficiencies not readily apparent from the separate implementation of each filter. For example, whitelists and blacklists generated using a challenge response filter can be applied to the message envelope prior to application of a silverlist filter to reduce the number of temporary failures and the number of unsolicited messages received by the mail processing unit.

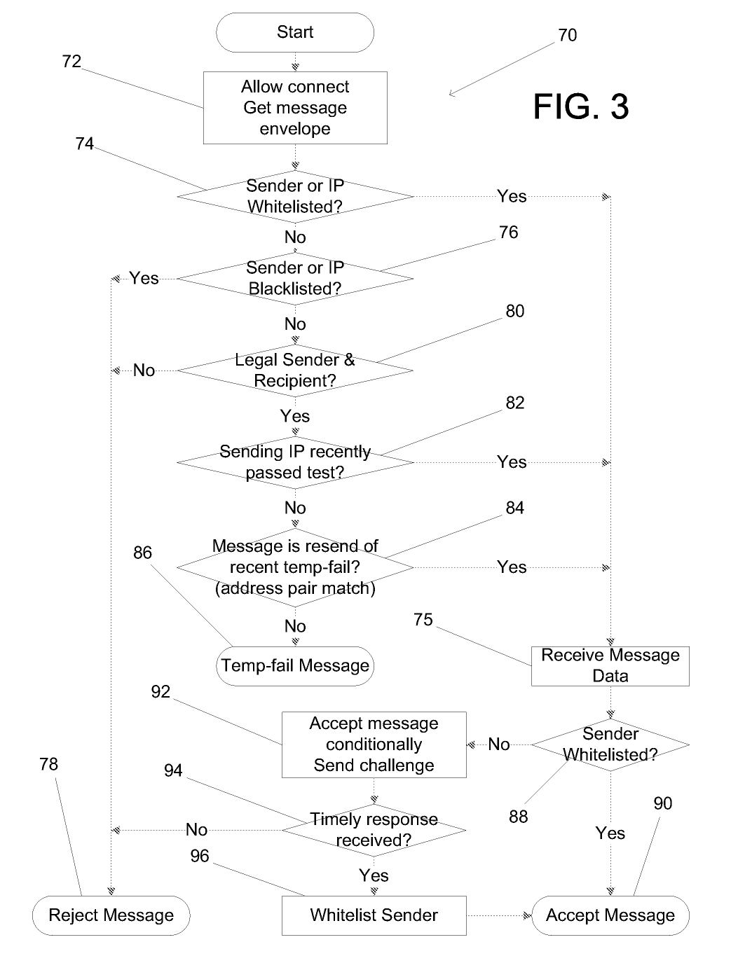

A process that can be used by a mail processing unit to filter messages using the combination of a silverlist filter, and a challenge response filtering in accordance with an embodiment of the invention is shown in FIG. 3. The process commences when a request to establish a connection and transmit a mail message is received. The process allows (72) the connection and obtains the message envelope. A determination (74) is made as to whether the sender email address or the sender IP address are whitelisted. When the sender email address or sender IP address are whitelisted, then the process requests (75) transmission of the message data.

When the sender email address and sender IP address are not whitelisted, many embodiments of the invention determine (76) whether the sender email address or sender IP address are blacklisted. When the sender email address or sender IP address are blacklisted, the message is rejected (78).

In many embodiments, whitelists can be constructed automatically using the contacts of users of a mail system. In addition, email addresses, IP addresses and domains can be added to a whitelist to reduce the number of temporary failures and challenge responses. Blacklists are typically manually constructed, but can also be automatically generated using a challenge response filter.

In the event the sender email address and the sender IP address are neither whitelisted nor blacklisted, then the process attempts to determine the sender's reputation. In the illustrated embodiment, the process of determining reputation commences with a determination (80) of whether the sender and recipient addresses are legitimate. A determination of whether the sender address is legitimate can be performed using tests appropriate to the application, such as but not limited to performing a DNS lookup, and determining whether the address is an allowable length and composed of only ASCII characters. The mail server can be consulted to determine whether the recipient address is valid. In the event that either address is determined not to be legitimate, then the message is rejected (78).

When the sender and recipient address of the message are legitimate, then the process determines (82) whether the sender IP address has a known reputation by determining whether the sender IP address has recently passed a temporary failure test. In many embodiments, a reputation database is consulted to determine whether the sender IP address has good reputation. When the sender IP address has good reputation, then the message data is requested (75). In the event that the sender IP address has unknown reputation, a determination (84) is made as to whether the message is a retry of a previously temporary failed message. The test can involve reviewing “waiting” records in a reputation database to determine whether the sender and recipient email addresses correspond. As discussed above, information indicative of the sender and recipient email addresses, such as hash values generated using the addresses, can be stored and used for the purpose of performing the comparison. When a match is found, the system assumes that the message is a retry in response to a temporary failure and requests (75) the transmission of the message data. When a match is not found, the process issues (86) a temporary failure and creates an appropriate “waiting” record in a reputation database. In many embodiments, hashes of addresses are stored and used to perform the various comparisons outlined above.

In the illustrated embodiment, a challenge response test is applied to the allowed messages to verify that the sender of the message is likely a human. The challenge response involves comparing (88) the sender address or sender domain to a whitelist. In the event that the sender is whitelisted, then the message is accepted (90). When the sender is not whitelisted, then the message is allowed conditionally and a challenge message is sent (92) to the sender. The challenge message requires a response from the sender. The response can simply be to reply to the message and often includes the requirement to solve a problem or answer a question that is a simple task for a human, but a complex task for a computer. In the illustrated embodiment, the sender simply is required to respond to the message. The process waits (94) for a response within a predetermined time period. When a response is not received within the predetermined time period, the message is rejected (78). When a response is received within the predetermined time period, then the sender is added (96) to the whitelist and the message is accepted (90).

A mail server that utilizes a process similar to the process outlined in FIG. 3 can build a whitelist and a blacklist (or multiple whitelists and blacklists) over time and use the lists to handle the majority of messages. The silverlist and challenge response filters can then be applied to messages from new senders. In many embodiments, the whitelist, blacklist and silverlist tests can be applied by a mail processing unit following the receipt of the message envelope and headers and prior to receipt of the message's data. Therefore, rejection of unsolicited messages using the blacklist and silverlist test can significantly reduce bandwidth usage due to the ability of the mail processing unit to refuse receipt of the payload portion of the message.

When a process similar to the process shown in FIG. 3 is applied at a mail server, the received messages can be held in a filter folder that can be accessed by individual recipients. Once the filters have been applied to the message, the message can be either moved to a recipient's inbox or to the recipient's deleted items folder depending upon the outcome of the various filtering processes.

In many embodiments, users can add information manually to whitelists and blacklists. Manual addition of information can prevent new acquaintances of a user from experiencing any perceived inconvenience that may be associated with the a retry delay and/or a challenge message.

Silverlist Filtering in Combination with Content Analysis

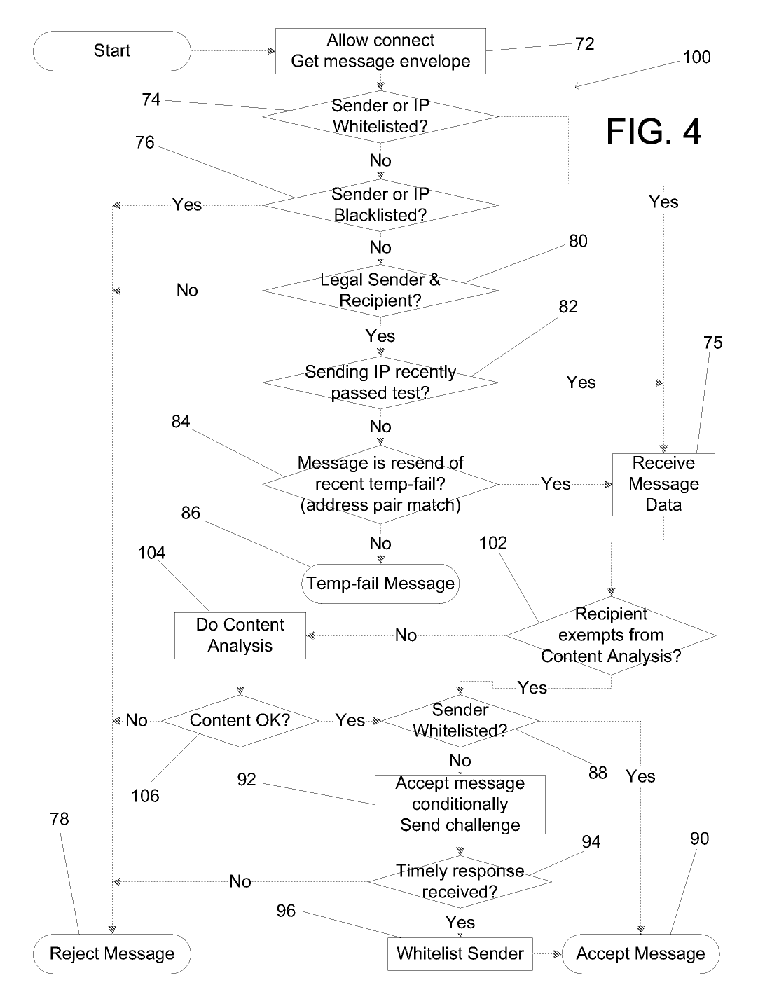

In many embodiments, a mail processing unit applies a silverlist filter in combination with a filter that examines the content of a message. A process for performing silverlist filtering, content filtering and challenge response filtering is shown in FIG. 4. The process 100 is similar to the process 70 shown in FIG. 3 with the exception that content analysis is performed after the message is silverlist filtered and prior to applying a challenge response filter. The content filtering involves receiving (75) the message data and then determining (102) whether the recipient has exempt messages from a sender from content analysis. In the event that the recipient has exempt the sender from content analysis, then the challenge response filter is applied to the message in a similar manner to that shown in FIG. 4. When the recipient is not exempt from content analysis, content analysis (106) is performed on the message and a determination (106) made concerning the whether the content of the message is suitable. Examples of content filtering include SPF checking of the addresses contained within the message header to confirm that they comply with the sending domains policy, using domain keys to authenticate the reputation of the sender (for example, using Domain Key Identified Mail as specified by the Mutual Internet Practices Association), using the Sender ID framework specified by Microsoft Corporation of Redmond, Wash., and/or any other filtering technique that utilizes the content of a message. When the content is not suitable, then the message is rejected (78). When the message content is acceptable, then a challenge response filter is applied to the message in a similar manner to the manner outlined above with respect to FIG. 3.

### Silverlisting as a Defense Against Spoofing

Spoofing of a common email address can be used to fool a mail filter. The presence of the spoofed email address on the whitelist of a user of the email system can enable the unsolicited email to pass through the mail filter undetected. In many embodiments, spoofing can be frustrated by application of a silverlist test. The silverlist test is applied based upon the sender's IP address prior to inspection of the sender's email address. Assuming the mail system that sends the spoofed messages is incapable of responding to a temporary failure, then the silverlist test successfully filters spoofed messages that would otherwise pass the whitelist of a filter that relies on sender address only.

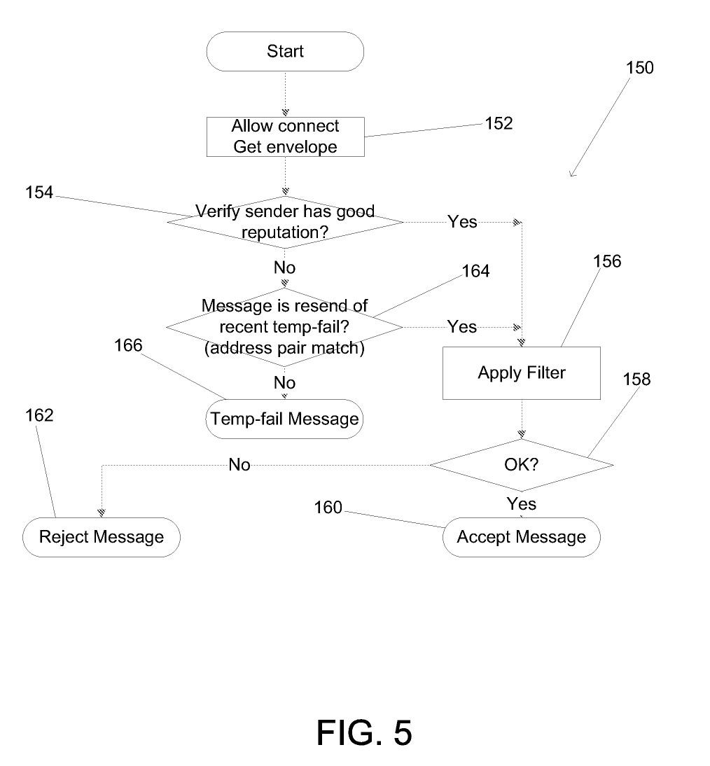

A process for filtering incoming mail messages using a silverlist filter to avoid spoofing is shown in FIG. 5. The process uses a silverlisting test to determine the reputation of a sender IP address prior to application of any other types of filter. Applying whitelists, blacklists and/or other types of filters after a message has passed a silverlist filter enables the filtering process to detect and reject messages with spoofed email addresses (i.e., addresses that appear on a whitelist, but with IP addresses that do not correspond to the IP address of a legitimate sender). The process 150 commences when an SMTP connection request is received. The connection is allowed 152 and the message envelope is received. The IP address of the sender is compared (154) to a sender IP address reputation database. When the IP address has good reputation, then the message is allowed and provided to any other filtering processes (156) used in combination with the silverlist filter. In a number of embodiments, the filters can include a whitelist, a blacklist, a Heuristic filter, a recurrent pattern filter, a Bayesian filter, a challenge response filter, and/or other types of filters. A determination (158) is made as to whether the message passes the filter. Message that pass the filter are allowed (160). Otherwise, the message is discarded (162)

When the reputation database does not contain information concerning the reputation of the sender's IP address, a determination (164) is made concerning whether the message is a resend of a recent temporary failure using the sender and recipient addresses. When the message is a resend, then the message is allowed and passed to any other filtering processes (156) used in combination with the silverlist filter. Otherwise a temporary failure is issued (166) with respect to the message. In many embodiments, comparisons of hashes of sender and recipient addresses are used instead of direct comparisons. In other embodiments, a silverlist filter is applied to an entire message and not just the message envelope, and additional information (such as, but not limited to, some other combination of headers) could be used as the basis of a hash or checksum to increase the likelihood of retry matching. In many embodiments, other techniques for increasing the likelihood of retry matching without storing information from a message are used.

Sharing reputation information can reduce the number of temporary failures issued to legitimate senders by the above process. As reputation information is collected concerning sender IP addresses that pass the silverlist test, the reputation information can be stored locally and/or uploaded to a global reputation database. The information can be continuously uploaded to the global reputation database or can be uploaded periodically as a batch. Given the sensitivity of many users to delays in receiving emails, limiting the number of temporary failures issued can positively impact user satisfaction.

While the above description contains many specific embodiments of the invention, these should not be construed as limitations on the scope of the invention, but rather as an example of one embodiment thereof. For example, much of the discussion focuses on mail processing units that service mail servers. In many embodiments, mail processing units serve specific email accounts on multiple mail servers and a single mail processing unit can handle messages destined for recipients on multiple mail servers. Accordingly, the scope of the invention should be determined not by the embodiments illustrated, but by the appended claims and their equivalents.

What is claimed is:

1. A process for filtering messages, comprising:
receiving a message envelope sent from a sender IP address, where the message envelope includes a sender address and at least one recipient address;
determining the reputation of the sender IP address;
allowing the message when the sender has a reputable sender IP address, irrespective of the sender and recipient addresses; and
performing a test when the sender IP address has unknown reputation, the test comprising:
issuing a temporary failure to the sender; and
detecting as a retry a message envelope received within a predetermined time period, where the sender and recipient addresses of the original message envelope and the received message envelope correspond; and
allowing the retry message.

2. The process of claim 1, wherein determining the reputation of the sender IP address of each message comprises determining whether the sender IP address has passed said test within a predetermined time period.

3. The process of claim 2, wherein determining whether the sender IP address has passed said test within a predetermined time period comprises consulting a reputation database containing a listing of sender IP addresses that have passed said test within a predetermined time period.

4. The process of claim 3, wherein consulting said reputation database comprises querying a local reputation database.

5. The process of claim 3, wherein consulting said reputation database comprises sending a query to a remote reputation server.

6. The process of claim 3, further comprising storing reputation information concerning a sender IP address in said reputation database in response to the outcome of said test.

7. The process of claim 2, wherein the message has a plurality of recipient addresses and further comprising performing said test with at least two of the recipient addresses.

8. The process of claim 7, further comprising determining whether a recipient has authorized performance of said test.

9. The process of claim 2, further comprising determining whether the sender and recipient addresses of the original message envelope and the retried message envelope correspond using hash values of the addresses.

10. The process of claim 1, wherein detecting a received message as a retry further comprises:
determining that the sender and recipient addresses of the original message envelope and the received message envelope correspond; and
determining that the sender IP addresses of the original message envelope and the received message envelope correspond.

11. The process of claim 1, further comprising:
comparing the sender address of the message envelope to a whitelist of sender addresses; and
allowing messages where the sender address of the message envelope appears on the whitelist.

12. The process of claim 1, further comprising:
comparing the sender address of the message envelope to a blacklist of sender addresses; and
refusing to allow messages where the sender address of the message envelope appears on the blacklist.

13. The process of claim 1, further comprising applying a challenge response filtering process to messages that are allowed.

14. The process of claim 13, wherein the challenge response filter process comprises:
sending a challenge message to the sender of the allowed message; and
providing the allowed message to the recipient when an appropriate response to the challenge message is received from the sender of the allowed message.

15. The process of claim 14, wherein the challenge response filtering process comprises:
comparing the sender address of the allowed message to a whitelist of sender addresses;
providing the allowed message to the recipient when the sender address of the allowed message is on the whitelist;
comparing the sender address of the allowed message to a blacklist of sender addresses;
rejecting the allowed message when the sender address of the allowed message is on a blacklist;
sending a challenge message to the sender address of the allowed message when the sender of the allowed message is neither on the whitelist or the blacklist; and
providing the allowed message to the recipient when an appropriate response to the challenge message is received from the sender of the allowed message.

16. The process of claim 1, further comprising applying a content filtering process to messages that are allowed by the silverlist filter.

17. The process of claim 1, wherein the message is destined for a remote mail server and the filtering process includes forwarding messages that pass the filtering process to the remote mail server.

18. A mail processing unit, comprising:
a network connection configured to receive connection information, message envelopes, and message data, where the connection information includes a sender IP address, and message envelopes include a sender address and a recipient address; and
a processor configured to determine the reputation of the sender IP address of each message;
wherein the processor is further configured to allow messages from senders having reputable sender IP addresses; and
wherein the processor is further configured to perform a test on messages from senders of messages having an IP address of unknown reputation, comprising:
transmitting a temporary failure message via the network connection to the sender of the a message having an IP addresses of unknown reputation;
detecting as a retry a message envelope received via the network connection within a predetermined time period, where the sender and recipient addresses of the original message envelope and the received message envelope correspond; and
allowing the retry message.

19. The mail processing unit of claim 18, wherein the processor is configured to determine the reputation of a sender IP address by determining whether the sender IP address has passed said test within a predetermined time period.

20. The mail processing unit of claim 19, wherein the processor is configured to determine whether the sender IP address has passed said test within a predetermined time period by consulting a reputation database containing a listing of sender IP addresses that have passed said test within a predetermined time period.

21. The mail processing unit of claim 20, wherein the processor is configured to query a local reputation database.

22. The mail processing unit of claim 20, wherein the processor is configured to transmit a query to a remote reputation server via the network connection.

23. The mail processing unit of claim 20, wherein the processor is further configured to store reputation information in the reputation database concerning a sender IP address in response to the outcome of said test.

24. The mail processing unit of claim 19, wherein the processor is configured to perform said test with respect to multiple recipient addresses, when a message includes a plurality of recipient addresses.

25. The mail processing unit of claim 24, wherein the processor is configured to determine whether a recipient has authorized performance of said test prior to performing said test.

26. The mail processing unit of claim 19, wherein the processor is configured to determine whether the sender and recipient addresses of the original message envelope and the retried message envelope correspond using hash values of the addresses.

27. The mail processing unit of claim 18, wherein the processor is configured to detect a received message as a retry by:
determining that the sender and recipient addresses of the original message envelope and the received message envelope correspond; and
determining that the sender IP addresses of the original message envelope and the received message envelope correspond.

28. The mail processing unit of claim 18, wherein the processor is configured to apply a whitelist filter to received message envelopes comprising:
comparing the sender address of the message envelope to a whitelist of sender addresses; and
allowing messages where the sender address of the message envelope appears on the whitelist.

29. The mail processing unit of claim 18, wherein the processor is configured to apply a blacklist filter to received message envelopes comprising:
comparing the sender address of the message envelope to a blacklist of sender addresses; and
refusing to allow messages where the sender address of the message envelope appears on the blacklist.

30. The mail processing unit of claim 18, wherein the processor is further configured to apply a challenge response filter to allowed messages.

31. The mail processing unit of claim 30, wherein the processor is further configured to:
send a challenge message to the sender of the allowed message; and
provide the allowed message to the recipient when an appropriate response to the challenge message is received from the sender of the allowed message.

32. The mail processing unit of claim 30, wherein the processor is further configured to:
provide the allowed message to the recipient when the sender address of the allowed message is on a whitelist;
reject the allowed message when the sender address of the allowed message is on a blacklist;
send a challenge message to the sender address of the allowed message when the sender address of the allowed message is neither on the whitelist or the blacklist; and
provide the allowed message to the recipient when an appropriate response to the challenge message is received from the sender of the allowed message.

33. The mail processing unit of claim 18, wherein the processor is further configured to apply a content filter to allowed messages.

34. The mail processing unit of claim 18, wherein the message is destined for a remote mail server and the processor is configured to forward allowed messages to the remote mail server.
